(19) United States
(12) Patent Application Publication
(10) Pub. No.: US 2011/0269624 A1
(43) Pub. Date: Nov. 3, 2011

(54) Agrochemical Compositions Comprising Branched Alcooxyalkanoates

(75) Inventor: Christian Sowa, Neustadt (DE)

(73) Assignee: BASF SE, Ludwigshafen (DE)

(21) Appl. No.: 13/142,341

(22) PCT Filed: Dec. 15, 2009
(86) PCT No.: PCT/EP2009/067137

§ 371 Date: Jun. 27, 2011

(30) Foreign Application Priority Data
Dec. 29, 2008 (EP) 08173004.6

(51) Int. Cl. A01N 25/26; A01P 21/00; A01P 7/00; A01P 13/00; A01N 43/653; A01N 43/56

(52) U.S. Cl. 504/100; 514/383; 504/139; 514/407

(57) ABSTRACT

The present invention relates to a liquid agrochemical composition comprising pesticide, formulation auxiliary and alkoxyalkanoate, and to a process for the preparation of this composition. The invention furthermore relates to an alkoxyalkanoate of the formula V

R³—C(O)—(O—R⁴)ₙ—OH V

where R³ is a branched C₇-C₉-alkyl, R⁴ is a C₂-C₄-alkylene, and n is 1 to 3.

The invention furthermore relates to the use of the alkoxyalkanoates V in agrochemical formulations. It furthermore relates to the use of the composition according to the invention for controlling phytopathogenic fungi and/or undesired vegetation and/or undesired attack by insects or mites and/or for regulating the growth of plants. Furthermore, it relates to the use of a composition according to the invention for controlling undesired attack by insects or mites on plants and/or for controlling phytopathogenic fungi and/or for controlling undesired vegetation, where seeds of useful plants are treated with the composition. Finally, the present invention also relates to seed treated with the composition according to the invention.

The present invention relates to a liquid agrochemical composition comprising pesticide, formulation auxiliary and alkoxyalkanoate, and to a process for the preparation of this composition. The invention furthermore relates to an alkoxyalkanoate of the formula V

R³—C(O)—(O—R⁴)ₙ—OH V

where R³ is a branched C₇-C₉-alkyl, R⁴ is a C₂-C₄-alkylene, and n is 1 to 3.

The invention furthermore relates to the use of the alkoxyalkanoates V in agrochemical formulations. It furthermore relates to the use of the composition according to the invention for controlling phytopathogenic fungi and/or undesired vegetation and/or undesired attack by insects or mites and/or for regulating the growth of plants. Furthermore, it relates to the use of a composition according to the invention for controlling undesired attack by insects or mites on plants and/or for controlling phytopathogenic fungi and/or for controlling undesired vegetation, where seeds of useful plants are treated with the composition. Finally, the present invention also relates to seed treated with the composition according to the invention. The present invention comprises combinations of preferred features together with other preferred features.

Agrochemical compositions comprising pesticide, formulation auxiliary and alkoxy-alkanoate are generally known:

WO 2004/010782 A2 discloses a method of controlling viruses in plants comprising bringing the plants into contact with a composition comprising a carboxylic ester having at least 14 carbon atoms. Ester groups which are listed are, for example, ethylene glycol, propylene glycol, polyethylene glycol and polypropylene glycol. The composition furthermore comprises a nonionic surfactant and optionally a pesticide.

JP 2005 112 727 A discloses a composition for the treatment of peach blossom, comprising a fatty acid ester of a C₈ to C₁₆-fatty acid. The alcohol moiety of the ester can be for example ethylene glycol or propylene glycol. The fatty acid can be for example a 2-ethylhexyl group.

JP 09 059 210 A discloses a solvent comprising 99-51% of an ester of a C₂₋₁₁-aliphatic acid with branched propylene glycol. The solvent is suitable for agrochemical compositions.

WO 2007/110435 discloses an aqueous microemulsion comprising a pyrethroid, an organic solvent and a surfactant mixture. Solvents which are described are, inter alia, C₁-C₄-alkyl esters of polyalkylene oxides which have 1, 2 or 3 alkylene oxide groups.

EP 1 911 349 A2 discloses a method for increasing the yield of agricultural produce by treating the latter with an alkoxy-(C₁₂₋₃₀)alkanoate.

JP 2004107214 A discloses an agrochemical formulation which floats on water and which comprises a surfactant, a high-boiling solvent, a hollow body which floats on water, and glass powder. Ethylene glycol monoesters of octanoic, nonanoic or decanoic acid are disclosed as surfactant.

Alkoxyalkanoates are also generally known:

In Environmental Pollution 2008, 151, 231-242, Grigoriadou et al. disclose 2-hydroxy-propyl 2-ethylhexanoate (formula 9), which has been identified during the analysis of water samples. A synthesis or isolation method is not disclosed.

EP 0 862 861 A1 discloses an insecticidal composition comprising a fatty acid ester selected from among, for example, propylene glycol monolaurate.

WO 99/30559 A1 discloses a method of destroying nematode eggs by employing a composition comprising a C₈ to C₁₄-fatty acid ester. The ester group is preferably ethylene glycol.

EP 1 151 667 A2 discloses a plant-activating compound selected for example from among esters of linear or branched C₁₂ to C₃₀-acids with polyethylene glycol or polypropylene glycol.

WO 2001/34898 discloses aqueous solutions comprising an aromatic formaldehyde condensate, an aliphatic carboxylic acid, an aromatic sulfonic acid and a solvent which may be, for example, a C₁-C₆-alkyl ester of polyalkylene oxides having 1 to 10 alkylene oxide units.

An object of the present invention was to provide a pesticide-comprising composition which makes possible a high pesticide load while being stable. In this context, stable means that the composition and in particular the composition when diluted with water shows little tendency to crystallize, if any. Furthermore, it was an object that the abovementioned composition should show little tendency to crystallize, both in the case of dissolved and suspended pesticides. Furthermore, it was an object to provide a pesticide-comprising composition in the form of an emulsion concentrate which shows little tendency to crystallize.

The object was achieved by a liquid agrochemical composition comprising pesticide, formulation auxiliary and alkoxyalkanoate, the alkoxyalkanoate having the formula I

R¹—C(O)—(O—R²)ₙ—OH I

where
R¹ is a branched C₃-C₁₅-alkyl,
R² is a C₂-C₄-alkylene, and
n is 1 to 3.

R¹ is a branched C₃-C₁₅-alkyl group. This means that the alkyl radical has three to 15 carbon atoms, and featuring at least one, preferably one to three, branches in the carbon chain. R¹ can be saturated or unsaturated; preferably, it is saturated. R¹ may also comprise cyclic structures; preferably, R¹ does not comprise any cyclic structures. R¹ is preferably a branched C₇ to C₁₁-alkyl, specifically a branched C₈- to C₉-alkyl.

In a preferred embodiment, R¹ is a structure of the formula A to J,

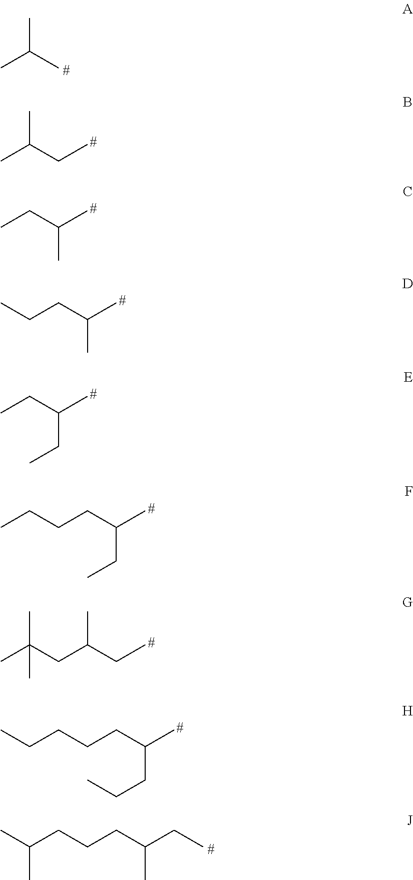

where # denotes the bond to the carbonyl group of formula I. R¹ is in particular a structure of the formula F, G or H.

R² is C₂-C₄-alkylene, for example —CH₂—CH₂—, —CH₂—CH(CH₃)—, —CH(CH₃)—CH₂—, —CH₂—CH(CH₂CH₃)—, —CH₂—CH₂—CH₂— or —CH₂—CH₂—CH₂—CH₂—. R² is preferably C₂-C₃-alkylene, for example —CH₂—CH₂— or —CH₂—CH(CH₃)—.

The index n can be within a certain range of values, for example 1 to 3. This means that not only integers such as 1, 2 or 3, but also values between integers, such as 1.15, may occur. n is preferably 1 to 2, especially preferably 1. In a further preferred embodiment, the alkoxyalkanoate is prepared by alkoxylating an acid, and n is 1.1 to 2.9, preferably 1.3 to 2.6.

Suitable alkoxyalkanoates I are, for example, the compounds of the formulae II, III and IV,

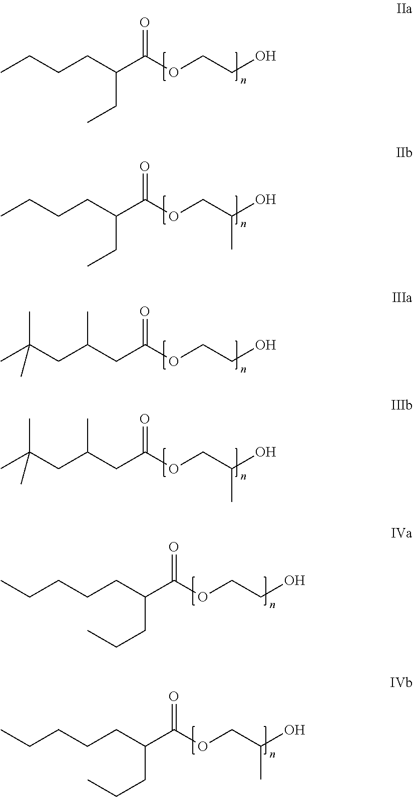

where n is a value of from 1 to 3, preferably from 1 to 2 and in particular 1.

The composition according to the invention usually comprises at least 20% by weight, preferably at least 30% by weight, especially preferably at least 40% by weight, of alkoxyalkanoate of the formula I based on the composition. In most cases, the composition comprises no more than 95% by weight, preferably no more than 90% by weight, especially preferably no more than 80% by weight, of alkoxyalkanoate I.

The expression pesticide refers to at least one active substance selected from the group consisting of the fungicides, insecticides, nematicides, herbicides, safeners and/or growth regulators. Preferred pesticides are fungicides, insecticides and herbicides, in particular fungicides. Mixtures of pesticides of two or more of the abovementioned classes may also be used. The skilled worker is familiar with such pesticides, which can be found, for example, in Pesticide Manual, 14th Ed. (2006), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazines, METI acaricides, and insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenon, or their derivatives. Suitable fungicides are fungicides from the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzylcarbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino-)pyrimidines, hydroxyanilides, imidazoles, imidazolinones, inorganic substances, isobenzofuranones, methoxyacrylates, methoxycarbamates, morpholins, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophene-carboxamides, toluamides, triphenyltin compounds, triazines, triazoles. Suitable herbicides are herbicides from the classes of acetamides, amides, aryloxyphenoxy-propionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenyl-carbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonyl-aminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

In one embodiment, the pesticide comprises an insecticide; preferably, the pesticide consists of at least one insecticide. In a further embodiment, the pesticide comprises a fungicide; preferably, the pesticide consists of at least one fungicide. Preferred fungicides are pyraclostrobin, metconazole and epoxyconazole. In a further embodiment, the pesticide comprises a herbicide; preferably, the pesticide consists of at least one herbicide. In a further embodiment, the pesticide comprises a growth regulator; preferably, the pesticide consists of at least one growth regulator.

In one embodiment, the pesticide is soluble in the alkoxyalkanoate to at least 10 g/l, preferably to at least 30 g/l and especially preferably to at least 50 g/l at 20° C. The solvent system employed here is the alkoxyalkanoate used in each case.

In a further embodiment, the pesticide is present in dissolved form in the liquid agrochemical composition. The pesticide is preferably dissolved in the solvent system at 20° C. to at least 90% by weight, preferably to at least 98% by weight, based on the pesticide.

In a further embodiment, at least one pesticide is suspended in the solvent system in the form of solid particles to at least 90% by weight based on the pesticide. If the composition comprises at least two pesticides, at least one pesticide is dissolved in the solvent system to at least 90% by weight. Preferably, the pesticide is suspended in the solvent system to at least 95% by weight, especially preferably to at least 98% by weight.

The composition according to the invention usually comprises from 0.1 to 70% by weight of pesticide, preferably from 1 to 50% by weight, in particular from 3 to 30% by weight, based on the composition.

The composition according to the invention comprises formulation auxiliaries, the choice of the auxiliaries usually depending on the specific use form or the active substance. Examples of suitable formulation auxiliaries are additional solvents, surfactants and other surface-active substances (such as solubilizers, protective colloids, wetters and adhesives), adjuvants, organic and inorganic thickeners, bactericides, antifreeze agents, antifoams, colorants and stickers (for example for feed treatment).

Suitable additional solvents, which may be present in the composition in addition to the solvent alkoxyalkanoate of the formula I, are organic solvents such as mineral oil fractions of medium to high boiling point, such as kerosene and diesel oil, furthermore coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol, benzyl alcohol and cyclohexanol, glycols, ketones such as cyclohexanone, gamma-butyrolactone, dimethyl fatty acid amides, fatty acids and fatty acid esters, and strongly polar solvents, for example amines such as N-methylpyrrolidone. It is preferred to use alcohols such as benzyl alcohol. In principle, it is also possible to use solvent mixtures. It is preferred to add, to the composition according to the invention, no more than 40% by weight, preferably no more than 20% by weight, in each case based on the composition.

Surfactants can be used individually or in the form of a mixture. Surfactants are compounds which reduce the surface tension of water. Examples of surfactants are ionic (anionic or cationic) and nonionic surfactants. The composition preferably comprises at least two surfactants; especially preferably, it comprises one nonionic surfactant and one anionic surfactant. The weight ratio of nonionic to anionic surfactant is in most cases 1:5 to 5:1, preferably 1:3 to 3:1.

Suitable ionic surfactants are the alkali metal, alkaline earth metal and ammonium salts of aromatic sulfonic acids, for example of lignosulfonic acid (Borresperse® types, Borregaard, Norway), phenol-, naphthalene- (Morwet® types, Akzo Nobel, USA) and dibutylnaphthalenesulfonic acid (Nekal® types, BASF, Germany), and of fatty acids, alkyl- and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polycarboxylates (Sokalan® types, BASF, Germany) or phosphate esters of alkoxylated alcohols.

Preferred ionic surfactants are anionic surfactants. Suitable anionic surfactants are alkali metal and ammonium salts of alkyl sulfates (alkyl radical: C₈ to C₁₂), of sulfuric monoesters of ethoxylated alkanols (degree of ethoxyiation from 4 to 30, alkyl radical: C₁₂ to C₁₈) and ethoxylated alkylphenols (degree of ethoxylation from 3 to 50, alkyl radical: C₄ to C₁₂), of alkylsulfonic acids (alkyl radical: C₁₂ to C₁₈) and of alkylarylsulfonic acids (alkyl radical: C₉ to C₁₈), or phosphate esters of an alkoxylated alcohol, specifically phosphate esters of an ethoxylated C₁₀₋₁₆-fatty alcohol with a degree of ethoxylation of from 3 to 15. Further anionic surfactants which are suitable are compounds of the general formula (I)

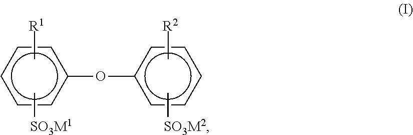

in which R¹ and R² are H atoms or C₄- to C₂₄-alkyl and are not simultaneously H atoms, and M¹ and M² can be alkali metal ions and/or ammonium ions. In the general formula (I), R¹ and R² are preferably linear or branched alkyl radicals having 6 to 18 C atoms, in particular 6, 12 and 16 C atoms, or hydrogen, where R¹ and R² are not both simultaneously H atoms. M¹ and M² are preferably sodium, potassium or ammonium, with sodium being especially preferred. Especially advantageous are compounds (I) in which M¹ and M² are sodium, R¹ is a branched alkyl radical having 12 C atoms and R² is an H atom or R¹. Frequently, technical mixtures are used which comprise 50 to 90% by weight of the monoalkylated product, such as, for example, Dowfax® 2A1 (brand of Dow Chemical Company). Preferred anionic surfactants are alkali metal and ammonium salts of alkylarylsulfonic acids (alkyl radical: C₉ to C₁₈), preferably linear or branched alkylbenzenesulfonic acids, and phosphate esters of an ethoxylated C₁₀₋₁₆-fatty alcohol with a degree of ethoxylation of from 3 to 15.

Suitable nonionic surfactants are polyoxyethylene octylphenol ethers, alkoxylated alcohols such as ethoxylated isooctyl-, octyl- or nonylphenol polyglycol ethers, tributyl-phenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors, and proteins, denatured proteins, polysaccharides (for example methylcellulose), hydrophobically modified starches, polyvinyl alcohol (Mowiol® types, Clariant), polyalkoxylates, polyvinylamine (Lupamin® types, BASF SE), polyethyleneimine (Lupasol® types, BASF SE), polyvinylpyrrolidone, and their copolymers or block copolymers. A suitable alkoxylated alcohol is preferably a fatty alcohol which is alkoxylated with ethylene oxide (EO) or propylene oxide (PO), in particular one with 8 to 32, specifically with 9 to 18, carbon atoms in the fatty alcohol residue. The alkoxylated fatty alcohol usually has a degree of ethoxylation of from 1 to 30, preferably from 2 to 10 and specifically from 4 to 8 ethylene oxide groups and/or a degree of propoxylation of from 1 to 30, preferably from 2 to 15 and specifically from 3 to 10 propylene oxide groups. The block polymer is usually a di- or tri-block polymer or a derivative thereof, the polymeric moiety being composed of ethylene oxide and propylene oxide. The mean molar mass is usually at least 1000 g/mol, preferably at least 2000 g/mol. A substance which is specifically suitable is poly(ethylene oxide block propylene oxide) alkyl ether with a molar mass of at least 2000 g/mol and a C₁₋₁₀-alkyl ether unit. Preferred nonionic surfactants are alkylphenol polyglycol ethers, tristyryl-phenol ethoxylates, ethoxylated castor oil, preferably having in each case 10 to 40 ethylene oxide units per molecule.

Suitable surface-active substances (adjuvants, wetters, stickers, dispersants or emulsifiers) in addition to the abovementioned surfactants are the alkali metal, alkaline earth metal and ammonium salts of aromatic sulfonic acids, for example of ligno-sulfonic acid (Borresperse® types, Borregaard, Norway), phenol-, naphthalene-(Morwet® types, Akzo Nobel) and dibutylnaphthalenesulfonic acid (Nekal® types, BASF), and of fatty acids, alkyl- and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors, and proteins, denatured proteins, polysaccharides (for example methylcellulose), hydrophobically modified starches, polyvinyl alcohol (Mowiol® types, Clariant), polycarboxylates (Sokalan® types, BASF), polyalkoxylates, polyvinylamine (Lupamin® types, BASF), polyethyleneimine (Lupasol® types, BASF SE), polyvinylpyrrolidone, and their copolymers.

The composition according to the invention can comprise large amounts of surface-active substances and surfactant. It can comprise a total amount of from 0.1 to 40% by weight, preferably from 1 to 30 and in particular from 2 to 20% by weight of surface-active substances and surfactants, based on the total amount of the composition.

Examples of adjuvants are organically modified polysiloxanes such as BreakThruS 240®; alcohol alkoxylates such as Atplus® 245, Atplus® MBA 1303, Plurafac® LF and Lutensol® ON; EO/PO block polymers, for example Pluronic® RPE 2035 and Genapol® B; alcohol ethoxylates, for example Lutensol® XP 80; and sodium dioctylsulfosuccinate, for example Leophen® RA.

Examples of thickeners (i.e. compounds which impart to the composition a modified flow behavior, i.e. high viscosity at rest and low viscosity in motion) are polysaccharides and organic and inorganic layer minerals such as xanthan gum (Kelzan®, CP Kelco), Rhodopol® 23 (Rhodia) or Veegum® (R.T. Vanderbilt) or Attaclay® (Engelhard Corp.).

Bactericides may be added to stabilize the composition. Examples of bactericides are those based on dichlorophen and benzyl alcohol hemiformal (Proxel® from ICI or Acticide® RS from Thor Chemie and Kathon® MK from Rohm & Haas) and isothiazolinone derivatives such as alkylisothiazolinones and benzoisothiazolinones (Acticide® MBS from Thor Chemie).

Examples of suitable antifreeze agents are ethylene glycol, propylene glycol, urea and glycerol.

Examples of antifoams are silicone emulsions (such as, for example Silikon® SRE, Wacker, Germany or Rhodorsil®, Rhodia, France), long-chain alcohols, fatty acids, salts of fatty acids, organofluorine compounds and their mixtures.

Examples of colorants are both pigments, which are sparingly soluble in water, and dyes, which are soluble in water. Examples which may be mentioned are the dyes and pigments known by the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108.

Examples of stickers are polyvinylpyrrolidone, polyvinyl acetate, polyvinyl alcohol and cellulose ethers (Tylose®, Shin-Etsu, Japan).

Compositions according to the invention are usually present in the form of agro-chemical formulations. Suitable agrochemical formulations are water-soluble concentrates (SL, LS), dispersible concentrates (DC), emulsifiable concentrates (EC), emulsions (EW, EO, ES, ME), suspensions (SC, OD, FS) or suspoemulsions (SE). The composition is preferably present in the form of an emulsifiable concentrate (EC). In a preferred embodiment, the composition according to the invention is present in the form of a liquid composition, such as water-soluble concentrates (SL, LS), redispersible concentrates (DC), emulsifiable concentrates (EC), emulsions (EW, EO, ES, ME), suspensions (SC, OD, FS) or suspoemulsions (SE).

In most cases, the composition according to the invention is diluted prior to use in order to prepare what is known as the tank mix. Substances which are suitable for the dilution are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydro-naphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone or water. It is preferred to use water. The dilute composition is usually applied by spraying or atomizing. Immediately before use (tank mix), oils of various types, wetters, adjuvants, herbicides, bactericides, fungicides may be added to the tank mix. These agents can be admixed with the compositions according to the invention in the weight ratio 1:100 to 100:1, preferably 1:10 to 10:1. The pesticide concentration in the tank mix can be varied in substantial ranges. In general, it is between 0.0001 and 10%, preferably between 0.01 and 1%. When used in plant protection, the application rates are between 0.01 and 2.0 kg of active substance per ha, depending on the nature, of the desired effect.

The present invention also relates to the use of a composition according to the invention for controlling phytopathogenic fungi and/or undesired vegetation and/or undesired attack by insects or mites and/or for regulating the growth of plants, where the composition is allowed to act on the respective pests, their environment or the plants to be protected from the respective pests, on the soil and/or undesired plants and/or the useful plants and/or their environment. The invention furthermore relates to the use of a composition according to the invention for controlling undesired attack by insects or mites on plants and/or for controlling phytopathogenic fungi and/or for controlling undesired vegetation, where seeds of useful plants are treated with the composition.

Furthermore, the invention relates to seed which has been treated with a composition according to the invention. The seed has preferably been dressed with the composition according to the invention. Dressing means that the seed has been treated with the composition and the composition remains on the seed. This composition can be applied to the seed in undiluted or, preferably, diluted form. Here, the composition in question can be diluted by a factor of 2 to 10, so that from 0.01 to 60% by weight, preferably from 0.1 to 40% by weight, of pesticide are present in the compositions to be used for dressing the seed. The application can take place before sowing. The treatment of plant propagation material, in particular the treatment of seed, is known to the skilled worker and is carried out by dusting, coating, pelleting, dipping or soaking the plant propagation material, the treatment preferably being effected by pelleting, coating and dusting, so that, for example, premature germination of the seed is prevented. In the treatment of seed, one will generally use pesticide amounts of from 1 to 1000 g/100 kg, preferably from 5 to 100 g/100 kg propagation material or seed.

The present invention also relates to a process for the preparation of a composition according to the invention, wherein a pesticide and an alkoxyalkanoate I are mixed. Preferred alkoxyalkanoates I and solvents are as described above. Mixing is effected by customary mixing processes, such as stirring, shaking or supplying energy in other forms. Further auxiliaries which are employed for the preparation of agrochemical formulations can be added in customary amounts. Examples of suitable formulation auxiliaries are as described above.

The present invention furthermore relates to alkoxyalkanoates of the formula V

R³—C(O)—(O—R⁴)ₙ—OH V

where
R³ is a branched C₇-C₉-alkyl,
R⁴ is a C₂-C₄-alkylene, and
n is 1 to 3.

R³ is a branched C₇-C₉-alkyl group. This means that the alkyl radical has seven to nine carbon atoms and features at least one, preferably one to three, branches in the carbon chain. R³ can be saturated or unsaturated, it is preferably saturated. R³ may also comprise cyclic structures; preferably, R³ does not comprise any cyclic structures. R³ is preferably a C₈ to C₉-alkyl.

In a preferred embodiment, R³ is a structure of the formula F to J,

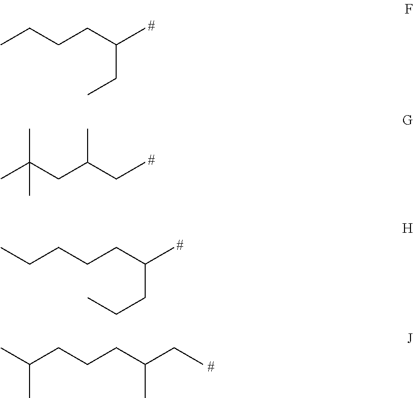

where # denotes the bond to the carbonyl group of formula I. R¹ is in particular a structure of the formula F, G or H, very specifically G or H.

R⁴ is C₂-C₄-alkylene, for example —CH₂—CH₂—, —CH₂—CH(CH₃)—, —CH(CH₃)—CH₂—, —CH₂—CH(CH₂CH₃)—, —CH₂—CH₂—CH₂— or —CH₂—CH₂—CH₂—CH₂—. R⁴ is preferably C₂-C₃-alkylene, for example —CH₂—CH₂— or —CH₂—CH(CH₃)—.

The index n can be within a certain range of values, for example 1 to 3. This means that not only integers such as 1, 2 or 3, but also values between integers, such as 2.15, may occur. n is preferably 1 to 2, especially preferably 1. In a further preferred embodiment, the alkoxyalkanoate is prepared by alkoxylating an acid, and n is 1.1 to 2.9, preferably 1.3 to 2.6.

Especially preferred alkoxyalkanoates V are, for example, the compounds of the formulae II, III and IV.

The pyrrolidone alkylene oxides of the formulae I to V can be prepared by alkoxylation of pyrrolidone. Substances which can be used for the alkoxylation are ethylene oxide, propylene oxide and butylene oxide. The alkoxylation can be catalyzed by strong bases, such as alkali metal hydroxides and alkaline earth metal hydroxides, Brönsted acids or Lewis acids, such as AlCl₃, BF₃. Catalysts such as hydrotalcite or double-metal cyanide (DMC) may be used for alcohol alkoxylates with a narrow distribution. The alkoxylation is preferably carried out at temperatures of from approximately 90 to 240° C., especially preferably from 110 to 190° C. The alkylene oxide or the mixture of a variety of alkylene oxides is pyrrolidone and catalyst charged under the vapor pressure of the alkylene oxide mixture which prevails at the selected reaction temperature, or at a higher pressure. If desired, the alkylene oxide can be diluted with an inert gas (for example noble gases, nitrogen, CO₂) up to 99.9%. In particular in the case of ethylene oxide, this additionally safeguards against gas-phase disintegration of this alkylene oxide, it also being possible, in this embodiment, to use a further alkylene oxide, for example propylene oxide, as inert gas within the meaning of the invention. Suitable alkoxylation conditions are also described in Nikolaus Schönfeldt, Grenzflächenaktive Äthylenoxid-Addukte, Wissenschaftliche Verlagsgesellschaft mbH, Stuttgart 1984. As a rule, the alkoxylation is carried out in the presence of the catalyst without addition of a solvent. However, the alkoxylation can also be carried out with the concomitant use of a solvent which is inert under the alkoxylation conditions.

In a suitable embodiment, the alkoxylation is catalyzed by at least one strong base. Examples of suitable strong bases are alkali metal alkoxides, alkali metal hydroxides, alkaline earth metal oxides or alkaline earth metal hydroxides. As a rule, the bases are employed in an amount of from 0.01 to 1% by weight based on the amount of pyrrolidone to be alkoxylated (cf. G. Gee et al., J. Chem. Soc. (1961), p. 1345; B. Wojtech, Makromol. Chem. 66, (1966), p. 180). An acid catalysis of the alkoxylation reaction is also possible. Besides Brönsted acids, Lewis acids such as, for example, AlCl₃, BF₃, BF₃-dietherates, BF₃×H₃PO₄, SbCl4×2 H2O, hydrotalcite (cf. P. H. Plesch, The Chemistry of Cationic Polymerization, Pergamon Press, New York (1963)) are also suitable.

The alkoxyalkanoates of the formula V are particularly suitable as alkoxyalkanoates in the composition according to the invention.

The present invention also relates to the use of the alkoxyalkanoates of the above-described formula V in agrochemical formulations. The alkoxyalkanoate is preferably used for dissolving a pesticide in an agrochemical formulation. Preferred alkoxy-alkanoates are as described above. Agrochemical formulations are known to the skilled worker. They usually comprise a pesticide and, optionally, auxiliaries for agrochemical formulations, for example the abovementioned auxiliaries for agrochemical formulations.

Advantages of the present invention are, inter alia, that it makes possible a composition with a high pesticide load while being stable. The composition and the composition diluted with water show little tendency to crystallize, if any. The composition is suitable both for dissolved and for suspended pesticides and in both cases shows little tendency to crystallize. Compositions in the form of emulsion concentrates, in particular, are stable and do not tend to crystallize.

The examples which follow illustrate the invention, without limiting it.

### EXAMPLES

Surfactant 1: Tristyrylphenol ethoxylate with 16 mol of ethylene oxide per mole (commercially available as Soprophor® BSU from Rhodia S.A.).
Surfactant 2: Calcium dodecylbenzenesulfonate (commercially available as Calsogen® AR 100 ND from Clariant).
Surfactant 3: Dodecylbenzenesulfonic acid, calcium salt (commercially available as Wettol® EM 1 from BASF).
Surfactant 4: nonionic surfactant based on ethoxylated castor oil (commercially available as Wettol® EM 31 from BASF).
Epoxyconazole: purity 95.5% by weight
Metconazole: purity 98.8% by weight
Pyraclostrobin: purity 99.4% by weight

### Example 1A

### 2-Ethylhexanoic acid+1 EO

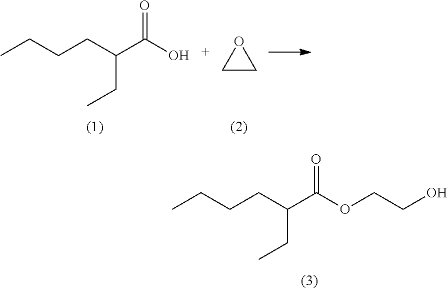

288.4 g (2.0 mol) of 2-ethylhexanoic acid (1) and 1.5 g of potassium hydroxide (50% by weight in water) were dehydrated on a rotary evaporator under nitrogen at 90° C. and 20 mbar. Thereafter, the mixture was transferred into a pressurized reactor, the pressure was brought to 1.5 bar using nitrogen, and 88.0 g (2.0 mol) of ethylene oxide (2) were metered in at 140° C. in the course of 1 h at a pressure of no more than 6.2 bar. After stirring had been continued for 15 h, the mixture was allowed to cool to 80° C. and, while stirring, was flushed with nitrogen; this gave 365 g of a pale yellow, clear product (3). The structure was confirmed by H NMR analysis.

### Example 1B

### 2-Ethylhexanoic acid+1 PO

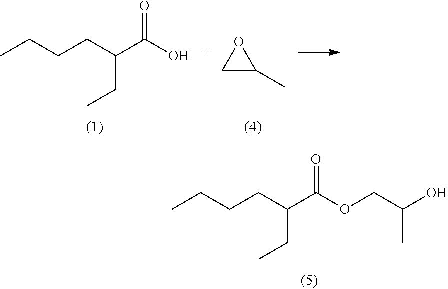

288.4 g (2.0 mol) of 2-ethylhexanoic acid (1) and 1.6 g of potassium hydroxide (50% by weight in water) were dehydrated on a rotary evaporator under nitrogen at 90° C. and 20 mbar. Thereafter, the mixture was transferred into a pressurized reactor, the pressure was brought to 1.5 bar using nitrogen, and 116.2 g (2.0 mol) of propylene oxide (4) were metered in at 140° C. in the course of 1 h at a pressure of no more than 4.9 bar. After stirring had been continued for 15 h, the mixture was allowed to cool to 80° C. and, while stirring, was flushed with nitrogen; this gave 399 g of a pale yellow, clear product (5). The structure was confirmed by H NMR analysis.

### Example 1C

### Isononanoic acid+1 PO

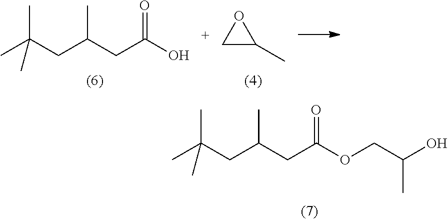

316.5 g (2.0 mol) of isononanoic acid (6) and 1.74 g of potassium hydroxide (50% by weight in water) were dehydrated on a rotary evaporator under nitrogen at 90° C. and 20 mbar. Thereafter, the mixture was transferred into a pressurized reactor, the pressure was brought to 1.5 bar using nitrogen, and 116.2 g (2.0 mol) of propylene oxide (4) were metered in at 140° C. in the course of 1 h at a pressure of no more than 4.9 bar. After stirring had been continued for 12 h, the mixture was allowed to cool to 80° C. and, while stirring, was flushed with nitrogen; this gave 440 g of a yellow, clear product (7). The structure was confirmed by H NMR analysis.

### Example 1D

### 2-Propylheptanoic acid+1 EO

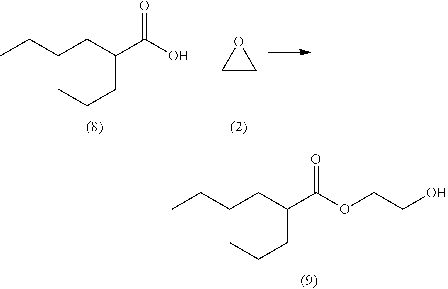

344.6 g (2.0 mol) of 2-propylheptanoic acid (8) and 1.74 g of potassium hydroxide (50% by weight in water) were dehydrated on a rotary evaporator under nitrogen at 90° C. and 20 mbar. Thereafter, the mixture was transferred into a pressurized reactor, the pressure was brought to 1.5 bar using nitrogen, and 88.0 g (2.0 mol) of ethylene oxide (4) were metered in at 140° C. in the course of 1 h at a pressure of no more than 7.2 bar. After stirring had been continued for 12 h, the mixture was allowed to cool to 80° C. and, while stirring, was flushed with nitrogen; this gave 441 g of a pale yellow, clear product (9). The structure was confirmed by H NMR analysis.

### Example 2

### Formulation of Epoxyconazole

5.2 or 10.4 g of epoxyconazole, 7.5 g of surfactant 1, 7.5 g of surfactant 2 and 12.5 g of benzyl alcohol were weighed in and made up to a total volume of 100 ml with alkoxyalkanoate of example 1. The mixture was mixed by stirring at room temperature until a clear homogeneous epoxyconazole solution was obtained.

| | Amount of | Alkoxyalkanoate of |
|---|---|---|
| Experiments | epoxyconazole | example |
| A | 5.2 g | 1 A |
| B | 5.2 g | 1 B |
| C | 5.2 g | 1 C |
| D | 5.2 g | 1 D |
| E | 10.4 g | 1 A |
| F | 10.4 g | 1 B |
| G | 10.4 g | 1 C |
| H | 10.4 g | 1 D |

In each case one sample of experiments A to F was diluted with CIPAC water D (comprising 342 ppm of Ca/Mg ions) to give a 1% by weight emulsion and left to stand for six hours at 20° C. During this time, no epoxyconazole crystals formed.

### Example 3

### Formulation of Pyraclostrobin

25.2 g of pyraclostrobin, 5.0 g of surfactant 3 and 5.0 g of surfactant 4 were weighed in and made up to a total volume of 100 ml with alkoxyalkanoate of example 1. The mixture was mixed by stirring at room temperature until a clear homogeneous pyraclostrobin solution was obtained.

| | Alkoxyalkanoate of |
|---|---|
| Experiment | example |
| A | 1 A |
| B | 1 B |
| C | 1 C |
| D | 1 D |

In each case one sample of experiments A to C was diluted with CIPAC water D (comprising 342 ppm of Ca/Mg ions) to give a 1% by weight emulsion and left to stand for six hours at 20° C. During this time, no pyraclostrobin crystals formed.

### Example 4

### Formulation of Metconazole

15.2 g of metconazole, 5.0 g of surfactant 3 and 5.0 g of surfactant 4 were weighed in and made up to a total volume of 100 ml with alkoxyalkanoate of example 1. The mixture was mixed by stirring at room temperature until a clear homogeneous metconazole solution was obtained.

| | Alkoxyalkanoate of |
|---|---|
| Experiment | example |
| A | 1 A |
| B | 1 B |
| C | 1 C |
| D | 1 D |

In each case one sample of experiments A to C was diluted with CIPAC water D (comprising 342 ppm of Ca/Mg ions) to give a 1% by weight emulsion and left to stand for six hours at 20° C. During this time, no metconazole crystals formed.

1-15. (canceled)

16. A liquid agrochemical composition comprising a pesticide, a formulation auxiliary and an alkoxyalkanoate, wherein the alkoxyalkanoate has the formula (I)
R¹—C(O)—(O—R²)ₙ—OH (I)
where
R¹ is a branched C₇-C₁₁-alkyl,
R² is a C₂-C₄-alkylene, and
n is 1 to 3.

17. The composition of claim 16, wherein at least 20% by weight of the alkoxyalkanoate of the formula (I), based on the composition, is present.

18. The composition of claim 16, wherein n is 1 to 2.

19. The composition of claim 16, wherein n is 1.

20. The composition of claim 16, wherein R¹ is a branched C₈ to C₉-alkyl.

21. The composition of claim 16, wherein the pesticide is present in dissolved form.

22. An alkoxyalkanoate of the formula V
R³—C(O)—(O—R⁴)ₙ—OH V
where
R³ is a branched C₇-C₉-alkyl,
R⁴ is a C₂-C₄-alkylene, and
n is 1 to 3.

23. The alkoxyalkanoate of claim 22, wherein n is 1 to 2.

24. The alkoxyalkanoate of claim 22, wherein R³ is a structure of the formula F, G, H or J 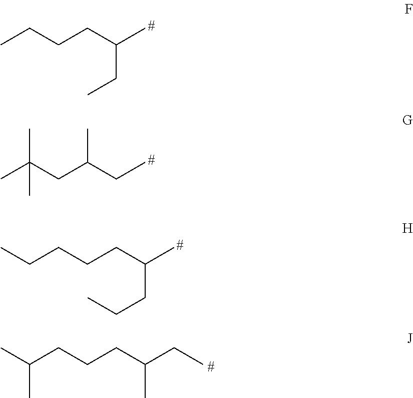
where # denotes the bond to the carbonyl group of formula V.

25. The alkoxyalkanoate of claim 24, wherein R³ is a structure of the formula G or H.

26. A method for controlling undesired attack by insects or mites on plants or for controlling phytopathogenic fungi and/or undesired vegetation and/or undesired attack by insects or mites and/or for regulating the growth of plants, comprising allowing the composition of claim 16 to act on the respective pests, their environment or the plants to be protected from the respective pests, on the soil and/or to undesired plants and/or the useful plants and/or their environment.

27. The method of claim 26, wherein the composition comprises at least 20% by weight of the alkoxyalkanoate of the formula (I), based on the composition.

28. The method of claim 26, wherein n is 1 to 2.

29. The method of claim 28, wherein n is 1.

30. The method of claim 27, wherein R¹ is a branched C₈ to C₉-alkyl.

31. The method of claim 27, wherein the pesticide is present in dissolved form.

32. The method of claim 27, wherein R³ is a structure of the formula F, G, H or J 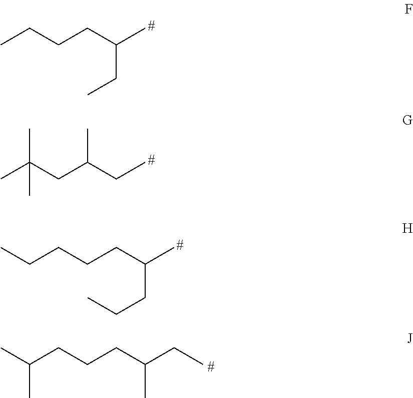
where # denotes the bond to the carbonyl group of formula V.

33. The method of claim 32, wherein R³ is a structure of the formula G or H.

34. The method of claim 33, wherein the composition comprises at least 20% by weight of the alkoxyalkanoate of the formula (I), based on the composition.

35. A method for controlling undesired attack by insects or mites on plants and/or for controlling phytopathogenic fungi and/or for controlling undesired vegetation, comprising treating seeds of useful plants with the composition of claim 16.

36. A seed dressed with the composition of claim 16, wherein the composition remains on the seed.
